(19) United States
(12) Patent Application Publication
(10) Pub. No.: US 2001/0052702 A1
(43) Pub. Date: Dec. 20, 2001

(54) Method and joint design for in-field water tight sealing of dual wall corrugated plastic pipe sections

(76) Inventor: Joseph M. Starita, Marysville, OH (US)

Correspondence Address: Edwin M. Baranowski, Porter Wright Morris & Arthur LLP, 41 South High Street, Columbus, OH, 43215, US

(21) Appl. No.: 09/794,638

(22) Filed: Feb. 27, 2001

Related U.S. Application Data
(63) Continuation-in-part of application No. 09/597,338, filed on Jun. 19, 2000.

(51) Int. Cl. F16L 17/00

(52) U.S. Cl. 285/371

(57) ABSTRACT

In-field watertight joints for dual wall corrugated plastic pipe sections utilized in drainage and sanitary sewer applications utilize pipe sections having end corrugations without external peripheral corners nearest the pipe ends and a method for forming a self-energizing water tight joint in corrugated plastic pipe.

### RELATED APPLICATION

This is a continuation-in-part of my pending application Ser. No. 09/597,338 filed on Jun. 16, 2000, the disclosure of which is incorporated herein as if set forth in full.

### FIELD OF THE INVENTION

This invention relates to methods for in-field or on-site forming of watertight seals between compliant pipe sections, specifically dual wall high-density polyethylene pipe utilized for drainage and sanitary sewer applications.

### BACKGROUND OF THE INVENTION

Dual wall corrugated plastic pipe sections are typically used for drainage applications for culvert, storm sewer, and irrigation applications. The drainage applications typically require a “soil tight” joining of pipe sections to prevent or limit soil infiltration and ex-filtration. In joints between dual wall corrugated plastic pipe sections, a pre-molded gasket is utilized to prevent soil infiltration and ex-filtration. Sanitary sewer applications typically require watertight joining of pipe sections to avoid the infiltration and ex-filtration of water. Dual wall corrugated high-density polyethylene pipe typically utilize pre-molded, field insertable, elastomeric gaskets that radially compress when pipe sections are mated. Joining the pipe sections and simultaneously compressing the elastomeric gasket requires high forces, typically exceeding 1000 pounds. The disadvantage of utilizing pre-molded gaskets for in field watertight sealing of pipe sections is leakage caused by (1) rolling of the pre-molded gasket due to misalignment of the adjoining pipe sections and high frictional forces between the compressing gasket and the pipe wall. The rolling causes the pre-molded gasket to twist and partially unseats the gasket providing a path for water to pass; (2) shipping and handling damage to the premounted gasket; and (3) high joining forces required to radially compress the pre-molded gasket requiring large and powerful equipment, for example, a backhoe.

In the past, watertight sealing of pipe sections was specified only for sanitary sewer applications. Currently, there exists an increasing trend for the federal, state and local authorities to specify watertight seals for drainage applications. The reinforced concrete, corrugated steel and corrugated plastic pipe industries anticipate legislation that will extend watertight requirements to all pipe sections utilized for drainage applications.

U.S. Pat. Nos. 4,480,855 and 4,509,911 to Larry A. Rosenbaum describe an integral mechanical latching mechanism on an internal collar for joining sections of single wall corrugated pipe. U.S. Pat. Nos. 5,326,138 and 5,415,436 to Timothy S. Claes et al. attempt joint solutions for dual wall corrugated plastic pipe whereby an external bell collar has a number of integral mechanical latches that function as a ratchet on external transverse corrugations. The latches lock the mating pipe ends in place while maintaining compression of sealing gaskets. Rosenbaum and Claes et al. address soil infiltration (soil tightness) and silt infiltration (silt tightness) but have not been able to reliably prevent ground water infiltration or ex-filtration (watertightness).

One of the main disadvantages of pre-molded gaskets is the hydraulic pressure applied to the projected annular area of the gasket that forces joined pipes to separate. The separating force on the joint can be represented by the expression:

F=PA=π(Rₒ²−R₁²)P

in which:

P=internal pressure in the corrugated plastic pipe

π=Pi

Rₒ=outer radius of the gasket

Rᵢ=inner radius of the gasket.

In a 72-inch diameter corrugated dual-wall pipe with 5-inch deep transverse corrugations, a force of over 1,000 pounds for each pound per square inch of internal pressure acts to separate the mechanical interlocks between joined pipe sections. The magnitude of the force caused by this hydraulic phenomenon is a major problem in maintaining watertight seals for dual wall corrugated plastic pipe and presents a barrier to their use in sanitary sewer applications. In this example 10 psi causes over 10,000 pounds of axial force to be applied to the pre-molded gasket. For dual wall corrugated high-density polyethylene pipe that is relatively flexible there is a high degree of deformation and distortion of the corrugations in proximity to the joint causing the pre-loaded compression of the gasket to diminish. Water simply flows by the gasket. Pre-molded gaskets require close dimension tolerances and nearly perfect alignment of the pipe sections during the joining or gasket setting process. It is rare that either condition is met.

U.S. Pat. Nos. 5,336,351 and 5,370,426 to Theodore W. Meyers describe a method of utilizing solvent weld glue on a connecting element, preferably polyvinyl chloride, on a polyethylene pipe, such that the solvent will dissolve, evaporate and harden. Although Meyers recognizes that polyethylene is chemically inert and does not require the polyethylene to dissolve or chemically react to form a joint, Meyers' patents require the molding of expensive polyvinyl chloride connectors and the use of relatively large amounts of hazardous solvents for large diameter pipe.

My pending application Ser. No. 09/597,338 filed on Jun. 16, 2000 discusses problems associated with misalignment at installation and the lack of dimensional control of the pipe sections. The self-energizing joint design disclosed provides watertight joints as long as the corrugations do not distort an amount sufficient to allow a separation between the molded-in-place gasket and the corrugation surface. Filling the corrugations that contact the molded gasket with rigid foam minimizes, and in most cases, eliminates the distortion of the corrugation. The stiffening of the end of the flexible pipe section combined with the self-energized mold-in-place elastomeric seal provides a watertight solution.

In summary, a means of fabricating a watertight joint that does not rely on the stiffness of the dual wall corrugated plastic pipe has been heretofore unavailable before my applications. There is a need for a reliable and cost effective means for watertight sealing of joints for dual wall corrugated polyethylene pipe. It is an object of this invention to provide a method and joint design that has the advantage of providing a watertight seal that prevents both infiltration and ex-filtration by utilizing the flexibility of the high-density polyethylene to push against a formed-inplace polymeric seat.

### SUMMARY OF THE INVENTION

This invention provides a watertight design for dual wall corrugated plastic pipe in which (1) pipe sections are adjacent and co-linear and corrugations at the pipe ends do not include outside peripheral corners nearest the pipe ends; (2) a collar or overlapping strap contacts the exterior lateral surface of the adjacent pipe sections in a manner such that the collar or strap straddles the two adjacent co-linear pipe ends and covers the open corrugations forming a peripheral channel that includes the open corrugations and the peripheral space therebetween; (3) tape, gasket, inner coupler, or other means prevents an injected mixture of curable components from dripping into the interior of adjoining pipe sections; (4) the injection of a mixture of curable components, capable of forming a solid polymer, peripherally fills the two open corrugations and the peripheral space between them at the joint; and (5) the absence of the corners on the end corrugations provides extending protrusions that act as valves providing self energized watertight seals by pushing against the cured elastomer contained within the split corrugations.

The present invention also provides a method for the in-field watertight sealing of corrugated pipe sections. Pipe sections, having end transverse corrugations without external corners closest to the pipe ends, are assembled by placing two sections in an adjacent co-linear manner such that pipe ends are in proximity. An external member and/or internal member maintain the pipe alignment and provide a closed peripheral channel that includes the two open transverse end corrugations on the joining pipes and the peripheral space between them. The closed peripheral channel is filled with the mixture of curable components having a viscosity, initially, sufficiently low to fill the channel and that increases sufficiently in chemical thixotropy wherein the mixture supports its own weight after filling. A structure results wherein the peripheral radial protrusions formed in the corrugations and at the joint, resulting from the curing of the mixture, act analogous to a pair of back-to-back check valves at each pipe end section that prevent fluid flow in either direction. The protrusions nearest the pipe end seal against internal pressure and the protrusions furthest from the pipe end seal against external pressure The present invention provides a system and method of joining large diameter dual wall transversely corrugated plastic pipe sections with benefits including the elimination of the projected area that exerts internal hydraulic pressure that acts to open a joint; enhanced joint strength independent of pipe stiffness; and a watertight field installable self-energizing seal.

The invention makes it possible for the corrugated polyethylene pipe industry to simultaneously enhance the strength of and to provide watertight sealing for dual wall corrugated high-density polyethylene pipe joints to meet present sanitary sewer and anticipated drainage pipe watertight specifications without redesigning and retooling.

The invention is described more fully in the following description of the preferred embodiment considered in view of the drawings in which:

### BRIEF DESCRIPTION OF THE SEVERAL VIEWS OF THE DRAWINGS

FIG. 1 is a transverse cross-sectional view of a watertight joint between two dual wall corrugated plastic pipe sections utilizing a standard external dual bell coupler and an internal coupler.

FIG. 2 is a transverse cross-sectional view of a watertight joint between two dual wall corrugated plastic pipe sections utilizing a standard external strap and an internal tape sealant.

FIG. 3A is a close-up of the transverse cross-sectional view of a watertight joint utilizing an external and internal coupler subjected to internal pressure.

FIG. 3B is a close-up of the transverse cross-sectional view of a watertight joint utilizing an external and internal coupler subjected to external pressure.

FIG. 4A is a close-up of the transverse cross-sectional view of a watertight joint utilizing an external strap and internal diameter tape sealant subjected to internal pressure.

FIG. 4B is a close-up of the transverse cross-sectional view of a watertight joint utilizing an external strap and internal diameter tape sealant subjected to external pressure.

FIG. 5 is an exploded frontal view showing the assembly of a joint that utilizes a dual bell coupler and an inner diameter preformed gasket sealant.

FIG. 6 is a close-up of the transverse cross-sectional view of the assembled joint with an external coupler and interior pre-molded gasket

FIG. 7 is a sketch depicting the filling of the channel in the field.

### DETAILED DESCRIPTION OF THE INVENTION AND THE PREFERRED EMBODIMENT

In brief, the invention discloses a joint design and a method for forming a watertight seal between dual wall corrugated plastic pipe sections at the site of installation. In the invention, adjacent and co-linear pipe sections of corrugated pipe include openings in the end corrugations at the outside peripheral corners nearest the pipe ends. A collar contacts the exterior lateral surface of the adjacent pipe sections such that the collar straddles the two adjacent co-linear pipe ends and encloses the open corrugations to form a peripheral channel that includes the two open corrugations at the pipe ends and the peripheral space between the pipe ends. A solid polymer formed from a mixture of curable components fills the open end corrugations and the space therebetween. The polymer filling the end corrugations, after the components cure, provides radial protrusions that act as valves at each pipe end forming self-energized watertight seals by pushing against the cured solid polymer contained within the open end corrugations. In the resulting structure, the peripheral radial protrusions nearest the pipe ends seal against internal pressure and the protrusions furthest from the pipe ends seal against external pressure.

A barrier member may be preferably disposed at the peripheral interface of the pipe ends to prevent the infiltration of the mixture of curable components into the interiors of the joining pipe sections.

The invention is also a method for in the field watertight sealing of corrugated pipe sections. Pipe sections having openings in the external corners on the end transverse corrugations closest to the pipe ends to be joined are assembled in an adjacent co-linear manner such that pipe ends are in proximity. A closed peripheral channel is formed between the inner and the outer circumferences of the corrugations of adjacent pipe sections. A peripheral member, which may be a member forming the channel, maintains the pipes in alignment. The closed peripheral channel is filled with a mixture of curable components capable of forming a solid polymer having a viscosity that is initially sufficiently low to fill the channel and increases in chemical thixotropy such that the mixture supports its own weight upon filling.

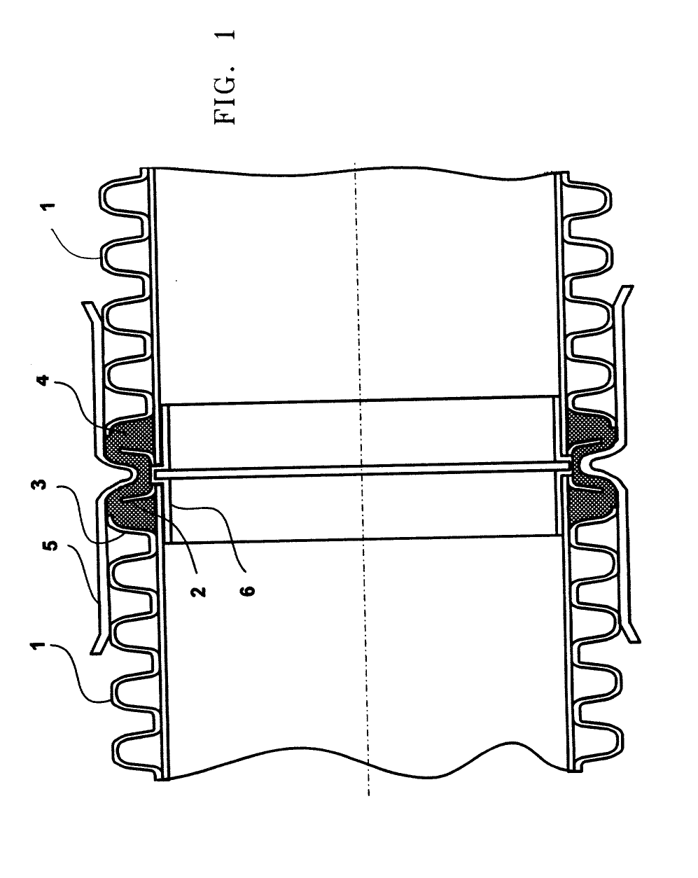

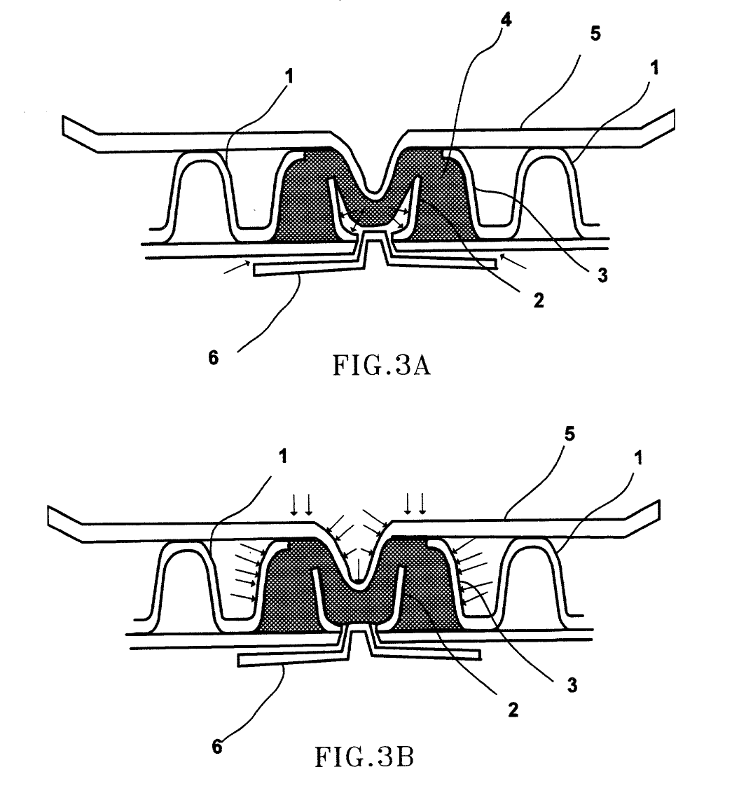

The watertight joint design for dual wall corrugated plastic pipe is shown in FIGS. 1, 2, 3A, 3B, 4A and 4B. FIG. 1 shows the dual wall corrugated plastic pipes 1 and the end corrugation with an opening in the external peripheral corner closest to the pipe end. The opening in the end corrugation results in a radial peripheral protrusion closest to the pipe end, referred to as the internal pressure valve 2 shown in FIGS. 1, 3A and 3B. The radial peripheral protrusion furthest from the pipe end, referred to as the external pressure valve 3, is shown in FIGS. 1, 3A and 3B.

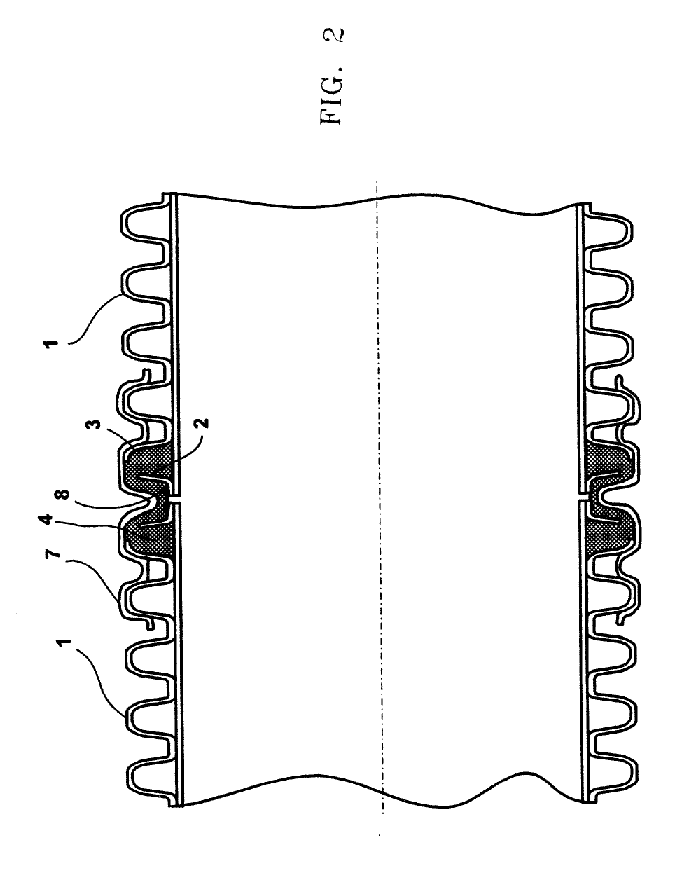

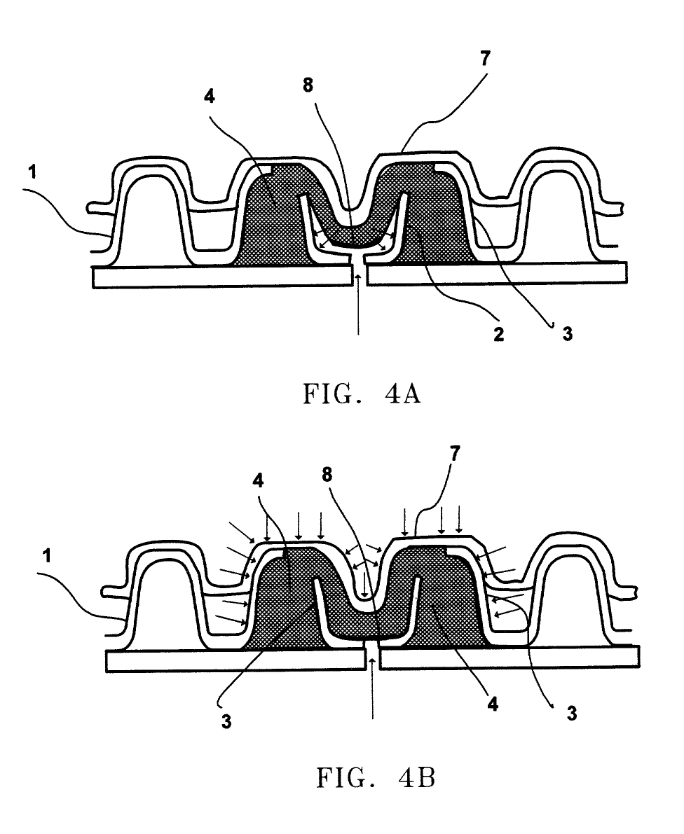

FIG. 1 shows a standard commercially available dual bell coupler 5, internal coupler 6, and the mixture 4 of curable components capable of forming a solid polymer. FIGS. 3A and 3B show the mixture after it has reacted to form a solid polymer 4. FIG. 2 shows a standard commercially available overlapping strap 7, a urethane or simple duct tape 8, and the mixture 4 of curable components capable of forming a solid polymer. FIGS. 4A and 4B show the mixture 4 after it has reacted to form a solid polymer.

A peripheral volumetric channel shown in FIGS. 1, 2, 3A, 3B, 4A and 4B is filled with the mixture 4 of curable components. The channel includes the interior of the end corrugations having openings at the peripheral corners nearest the ends of the pipe sections and the space between the end corrugations bounded by the interior surface of the dual bell coupler 5 shown in FIG. 1, 3A and 3B and/or the interior surface of the strap 7 shown in FIGS. 2, 4A and 4B surrounding the pipe. The channel provides means for containing the mixture of curable components capable of forming a solid polymer. The containment means for the dual bell coupler joint shown in FIGS. 1, 3A and 3B is an interior coupler 6, or for the strap joint shown in FIGS. 2, 4A and 4B, is an overlapping tape 8. The dual bell coupler and the strap joints can also function with a premolded gasket replacing the interior coupler and the tape.

The composition is cured in situ to produce a secure seal and joint between two pipes. The curable composition is preferably a mixture of curable components that initially form a chemical thixotrope that subsequently cures to form a solid polymer. In a typical application, the viscosity of the components at the time of injection is in the range of approximately 200 centipoise. The mixed components first produce a viscous fluid that ultimately forms a gel as the mixture flows into the peripheral channel. The gel develops a yield stress sufficient to be self-supporting by the time the material reaches the bottom of the channel to be filled. Useful viscosities are dependent on shape, configuration and volume of the peripheral channel. An example of preferred characteristics of the mixture of curable components has a viscosity of 200 to 10,000 centipoise, at the entrance of a static mixer. In an example using an 18-inch pipe, the fill in the circumferentral channel was done at low pressure in a period of 3 to 5 minutes.

The mixture of components exiting the static mixer achieves a viscosity exceeding 70,000 centipoise upon gelling. Its yield stress increases during the filling of the channel wherein the mixture becomes self supporting during the filling process, minimizing leakage outside the channel and into the interior of the pipe. The mixture cures forming a solid polymer that is an elastomer or a rigid polymer.

Polyureas, such as referred to in my previous application, are preferred because their reactions proceed independent of the presence of water, wherein installation on wet pipe sections can be accomplished by filling the channel and displacing the water. The resulting polymer solid is a elastomer with a Shore A hardness in the range of 70 to 90. Polyurethanes provide an acceptable alternative for dry installations. Epoxy resins can be utilized to form a polymer solid that is a glassy polymer having a modulus in the order of 10¹⁰ dynes per square centimeter thereby providing a more rigid joint. Silicones can be utilized; however, they have a high cost.

This invention is a watertight joint that is accomplished by the combination of the peripheral radial protrusions 2 and 3 shown in FIGS. 1, 2, 3A and 3B that result from the absence of the corners nearest the pipe end on the end corrugations and the solid polymer 4 contained within the peripheral volumetric channel.

FIGS. 3A and 4A illustrate how protrusions 2 act as valves that prevent the flow of water in the presence of internal hydrostatic pressure. The valves are pushed against the confined solid polymer by the water, thereby creating a self-energizing seal. FIG. 3B and 4B show how protrusions 3 act as valves in the presence of external hydrostatic pressure. In the context of the invention, “self-energizing” refers to a joint design whereby increasing the pressure applied by the water causes a flexible member to exert a corresponding increased pressure against a confined solid polymer similar to the action of a check valve. In this case, the higher the pressure is, the stronger the seal becomes.

The low energy surface of the polyethylene inhibits adhesion and thereby all but eliminates the possibility of gluing joints together. The relatively low modulus and high creep characteristics of high-density polyethylene, as compared to metals or concrete, result in flexible and compliant pipe sections that have difficulty maintaining a pre-load on a compressed gasket. In other words, dual wall corrugated high density polyethylene pipe lacks the precision, dimensional stability and rigidity required for a reliable water tight seal based on a compressed pre-formed gasket approach and has such a low energy surface that adhesive joints are impractical. There is one other option and that requires infield welding of the polyethylene pipe sections. However, the large equipment, labor and cost of infield welding all but eliminate welding as a practical solution. As a result, the self-energizing design disclosed herein is a necessary and sufficient design for convenient and cost effective in-field watertight joining of dual wall corrugated high-density polyethylene pipe sections.

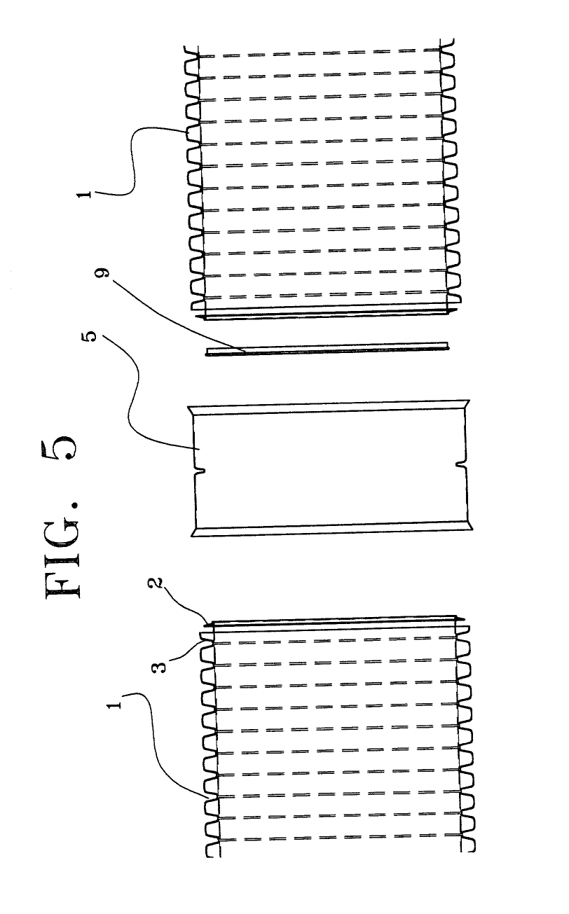

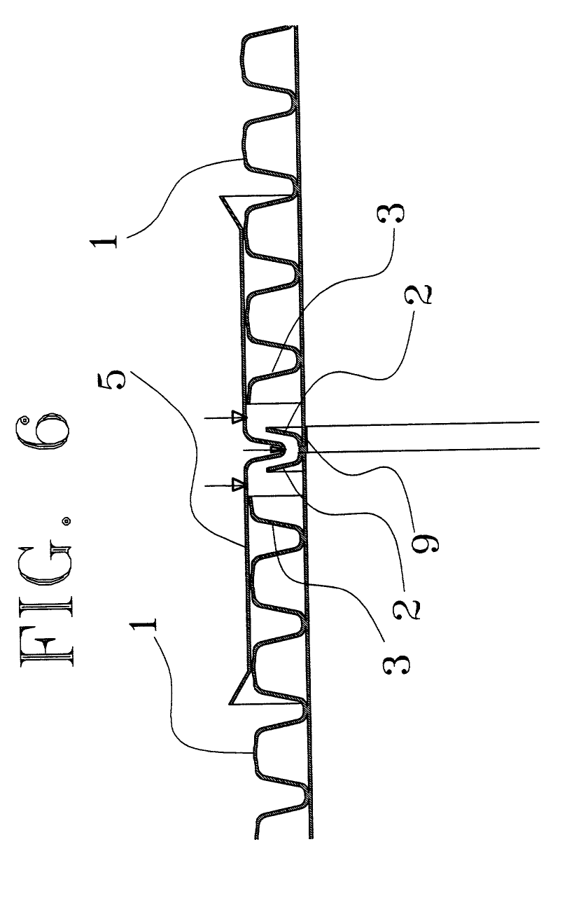

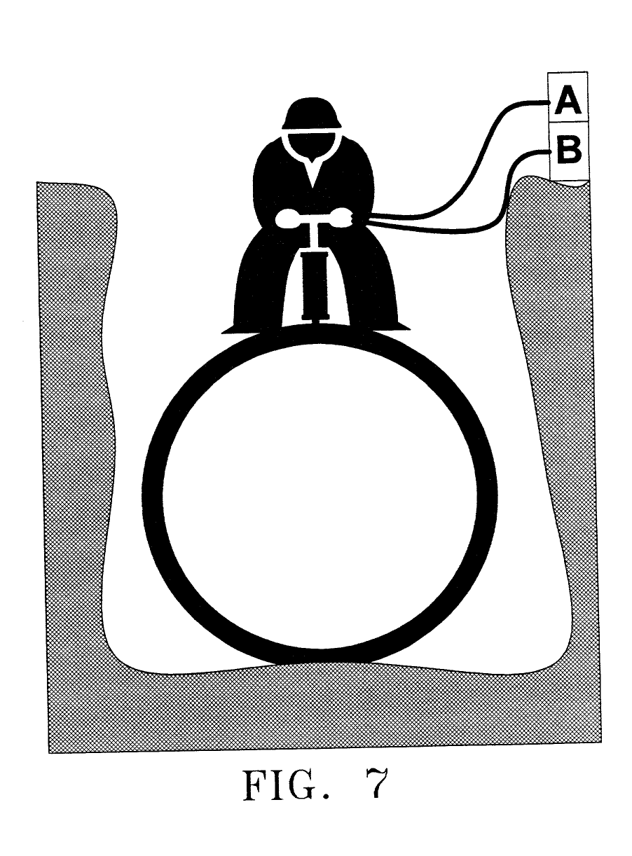

The method of forming a watertight joint is illustrated in part by FIGS. 5, 6 and 7. The dual wall corrugated plastic pipe sections 1 is shown in FIG. 1 with a standard dual bell coupler 5 and preformed interior gasket 9. The first step is to apply the gasket 9 to the inside diameter of a pipe end to be joined. It is preferable that the gasket has an adhesive coating on the outside diameter so that the gasket is held in place when the dual bell coupler is slid into place over the end of the pipe section having the gasket. The second pipe section is then placed inside the open end of the dual bell coupler. The two pipe ends tend to compress the gasket slightly. A close-up of the peripheral joint cross section is shown in FIG. 6 before it is filled with the mixture of curable components that form a solid polymer. FIG. 7 shows how the assembled joint may be filled with a two component mixture of components A and B capable of forming a solid polymer. The three arrows in FIG. 6 represent fill points. This embodiment illustrates a dual bell coupler utilized in conjunction with an interior gasket. In the Air embodiment shown in FIGS. 2, 4A and 4B tape is used to seal the interior and a standard strap is utilized on the exterior.

Having described the invention in detail, those skilled in the art will appreciate that, given the present disclosure; modifications may be made to the invention without departing from the spirit of the inventive concept herein described. Rather, it is intended that the scope of the invention be determined by the appended claims.

1. A watertight joint for dual wall corrugated plastic pipe comprising:
adjacent and co-linear corrugated pipe sections in which the corrugations at the pipe ends have an opening at the outside peripheral corners nearest the pipe ends;
a collar contacting the exterior lateral surface of the adjacent pipe sections such that the collar straddles the two adjacent co-linear pipe ends and encloses the open corrugations to form a peripheral channel that includes the two open corrugations at the pipe ends and the peripheral space therebetween;
a polymer formed from a mixture of curable components filling the volume defined by the open corrugations and the collar.

2. The joint of claim 1 further including a barrier member disposed at the perimeter surfaces of the pipes at the interface of the pipe ends.

3. The joint of claim 1 in which the polymer is a rigid polymer.

4. The joint of claim 1 in which the polymer is an elastomeric polymer.

5. A method for in the field watertight sealing of corrugated pipe sections having an inner liner and an outer transverse corrugation comprising:
providing openings in each pipe at approximately the external corners of the transverse corrugation closest to the pipe ends;
placing the two pipe sections in an adjacent co-linear manner such that pipe ends are in proximity;
enclosing the inner liner and the outer circumference of the corrugation of adjacent pipe sections with at least one member to maintain the pipe alignment and provide a closed peripheral channel that includes the volume within the open corrugations at the pipe ends and the space between the end corrugations;
filling the closed peripheral channel with a mixture of fluid components that cure into a polymer, the mixture having a viscosity that is initially sufficiently low to fill the channel and thereafter increases in chemical thixotropy such that the mixture supports its own weight upon filling; and
allowing the mixture to cure.
